(19) United States
(12) Patent Application Publication
(10) Pub. No.: US 2008/0148189 A1
(43) Pub. Date: Jun. 19, 2008

(54) SYSTEMS AND METHODS FOR PROVIDING A USER INTERFACE

(76) Inventor: Istvan Szent-Miklosy, New York, NY (US)

Correspondence Address: STRATEGIC PATENTS P.C.., C/O PORTFOLIOIP, P.O. BOX 52050, MINNEAPOLIS, MN, 55402, US

(21) Appl. No.: 11/860,801

(22) Filed: Sep. 25, 2007

Related U.S. Application Data
(60) Provisional application No. 60/826,941, filed on Sep. 26, 2006.

(51) Int. Cl. G06F 3/048

(52) U.S. Cl. 715/848

(57) ABSTRACT

In embodiments of the present invention improved capabilities are described for providing a user with a convenient and intuitive user interface for performing tasks within projects, wherein the tasks may be related to content objects; for organizing content objects within projects, between projects, and with respect to one another; and for organizing projects with respect to one another.

### CROSS-REFERENCE TO RELATED APPLICATIONS

This application claims the benefit of the following provisional application, which is hereby incorporated by reference in its entirety: U.S. provisional patent application Ser. No. 60/826,941 filed Sep. 26, 2006.

### BACKGROUND

The personal computer, while widely adopted and very valuable for certain kinds of tasks, has significant problems when used for knowledge work. First, users have great difficulty maintaining concentration while working back and forth across multiple units of content. Second, users find it very difficult to manage the practical orchestration of the disparate and broad array of documents that users employ in the course of ongoing projects. One notable aspect of the user experience is the jumble of windows that perpetually take over and clutter personal computer screens. A less evident aspect is that the disparate elements of the desktop scheme lack any governing logic, so the visual tableau that greets a user creates perceptual confusion, as its individual objects and the spaces that contain them are depicted independently of one another.

The absence of coherence in the presentation of spaces and objects means that production of action, of the operations users perform to navigate the desktop environment and handle the objects within it, is inefficient. The desktop scheme makes working with screen documents distracting and unwieldy, and thereby squanders the scarce attention users would rather have available to focus completely on work.

Thus, a need exists for methods and systems that more coherently present and range of content objects and spaces that contain content objects within computer environments, including personal computer environments.

These and other systems, methods, objects, features, and advantages of the present invention will be apparent to those skilled in the art from the following detailed description of the preferred embodiment and the drawings.

### SUMMARY

Correcting the current situation involves a range of approaches to designing the space, objects, and actions that together comprise a user's on-screen experience. One approach involves coordination. Users need a governing logic that is both comprehensive and effective. Thus, methods and systems are disclosed that adhere to design rules that provide consistent, coordinated experiences. A second approach involves amalgamation, or consolidation, of screen elements. The fewer elements a user needs to engage, the more effective and efficient a user can be during use of the system. In current systems the surfeit of widgets and operations celebrate tinkering at the expense of elegant usability. A third approach involves unit orientation and modularity. Things need scale and need a grammar to let them be combined coherently. Each individual element needs to fit clearly into larger groupings, and the control a user has needs to have just the right degree of directness, enough to fit the activity, yet not too much to then detract from the larger purpose. The methods and systems disclosed herein use these three approaches to provide a more coherent, manageable user experience.

In one aspect of the invention, a working environment is provided, referred to herein as the tower working environment, or the tower representation, which provides a visual representation of the user's workspaces, presented in adjacency to each other. The tower working environment provides an unambiguous working territory that makes a user's work, including work involving many diverse projects, easy to manage and easy to keep track of. The tower working environment takes the mystery out of screen space. A user can control where things go, the structure of space, and the organization of materials.

In another aspect of the invention, a universal mechanism is used to represent content objects, such as document. In embodiments of the methods and systems disclosed herein, the content objects, such as documents, that user see are presented using a common display and handling mechanism, eliminating arbitrary differences in navigating content, such as in switching between documents, because documents use the same presentation mechanisms. As a result, a user's attention doesn't get frittered away managing artificial differences.

In certain embodiments the methods and systems disclosed herein also employ a focus action system, which should be understood to encompass a method or system that fits a user's work, and that is fit to the screen. Instead of managing windows, a user manages the focus of what appears on the screen. Content objects can be provided with a default position, and operating the system consists of switching what content object is in the focus position within a workspace. As a result, the presentation of objects remains orderly on the screen.

Provided herein are methods and systems for allowing a user to interact with one or more resources of a computer system. The methods and systems may include providing a tower-based visual representation of a plurality of workspaces disposed in apparent physical adjacency to each other, at least two of the workspaces being disposed vertically in the visual representation, at least one of the workspaces being presented to the user in a 3D visualization to resemble a physical room. In embodiments, upon a shift of the viewpoint of a user of the visual representation, the user is presented with a continuous perceptual representation of the workspaces.

The methods and systems may further include providing a workspace in which a user can interact with one or more content objects and enforcing an action grammar for actions associated with the workspace, whereby movement of content objects within the workspace occurs only in response to a user action.

The methods and systems may further include enabling a change of viewpoint within the visual representation of a plurality of workspaces, wherein the change in viewpoint from one workspace to another workspace is presented to the user in a manner that corresponds to the view a user would experience if the user were to make a movement in the physical world.

The methods and systems may further include providing a workspace for interacting with content objects, the workspace having a predefined set of positions for the content objects, the predefined set of positions remaining invariant, the positions configured to receive content objects for interaction by a user.

The methods and systems may further include enabling a change of viewpoint within the visual representation, whereby a workspace is sequentially in the view of the user, outside the view of the user and back in the view of the user and during the change of viewpoint, preserving the positions of the content objects in the workspace, so that upon returning to a viewpoint where the workspace is in view of the user, the positions of the content objects are the same as before the viewpoint changed to a viewpoint where the workspace was not visible to the user.

The methods and systems may further include, within a workspace of a visual representation of one or more resources, representing a plurality of content object types with a common presentation mechanism, the common presentation mechanism presenting various content object types in the same manipulable form within a workspace, regardless of content object type.

The methods and systems may further include enforcing an action grammar for content objects within workspaces of a visual representation under which the position of a content object in a workspace is preserved in the visual representation of the workspace until the content object is moved at the direction of a user. In embodiments the persistence is maintained during the departure from and return to the workspace by a user.

The methods and systems may further include enabling a plurality of positions in a workspace of a visual representation, wherein the positions include at least one of a focus position in which a user can manipulate a content object, a side location in which a user can place content objects, an access facility for displaying items for optional delivery to the workspace and an episodic position for grouping related content objects.

The methods and systems may further include providing a visual representation of a plurality of workspaces, the workspaces including a routing workspace for routing content objects into the visual representation and among workspaces, a staging workspace for staging content objects and an episodic workspace for grouping and working on a plurality of related content objects.

The methods and systems may further include enabling a swap operation within a workspace under which movement of a content object into a focus position of the workspace swaps the display of the content object that was previously displayed in the focus position into a defined return location that is based on a characteristic of the content object.

All documents referenced herein are hereby incorporated by reference.

### BRIEF DESCRIPTION OF THE FIGURES

The invention and the following detailed description of certain embodiments thereof may be understood by reference to the following figures:

FIG. 1 depicts a system according to the present invention.

FIG. 2 depicts a workspace.

FIG. 3 depicts a visual manifestation of a logical space, including a tower representation.

FIG. 4 depicts a snapshot of an animation, showing a portion of a tower representation.

FIG. 5 depicts a snapshot of a tower representation, representing a point during which a user zooms in on a part of the tower representation.

FIG. 6 depicts a navigation actuation panel that allows a user to navigate to a project or workspace that is represented in the tower representation.

FIG. 7 depicts a series of content surfaces in a pile of content objects.

FIG. 8 depicts a snapshot of an animation showing a type of workspace within the tower representation.

FIG. 9 depicts a staging workspace within the tower representation.

FIG. 10 depicts an access facility for local documents search.

FIG. 11 depicts an access facility for web documents search.

FIG. 12 depicts an access facility for displaying a list of annexed content.

FIG. 13 depicts a control bar associated with a workspace.

FIG. 14 depicts a common embodiment facility for representing a content object.

FIG. 15 depicts a mail address bar.

FIG. 16 depicts a document delivery action.

FIG. 17 depicts movement of a content object from a focus position to another position in the workspace.

FIG. 18 depicts movement of a content object into a focus position from another position in the workspace.

FIG. 19 depicts swapping the positions of two content objects within the workspace.

FIG. 20 depicts a hypertext link action.

FIG. 21 depicts a transition from a staging workspace to an episodic workspace.

FIG. 22 depicts an episodic workspace.

### DETAILED DESCRIPTION

An aspect of the present invention provides systems and methods for providing a user with a convenient and intuitive user interface for performing tasks within projects, wherein the tasks may be related to content objects; for organizing content objects within projects, between projects, and with respect to one another; and for organizing projects with respect to one another. In embodiments the methods and systems may provide a user interface for a personal computer, or for one or more portions of a personal computer, such as applications or workspaces within the personal computer. The following detailed description of the figures discloses these and many other aspects of the present invention. Still other aspects of the present invention will be appreciated from the both the following detailed description of the figures and from the figures themselves. All such aspects of the present invention are intended to fall within the scope of the present invention.

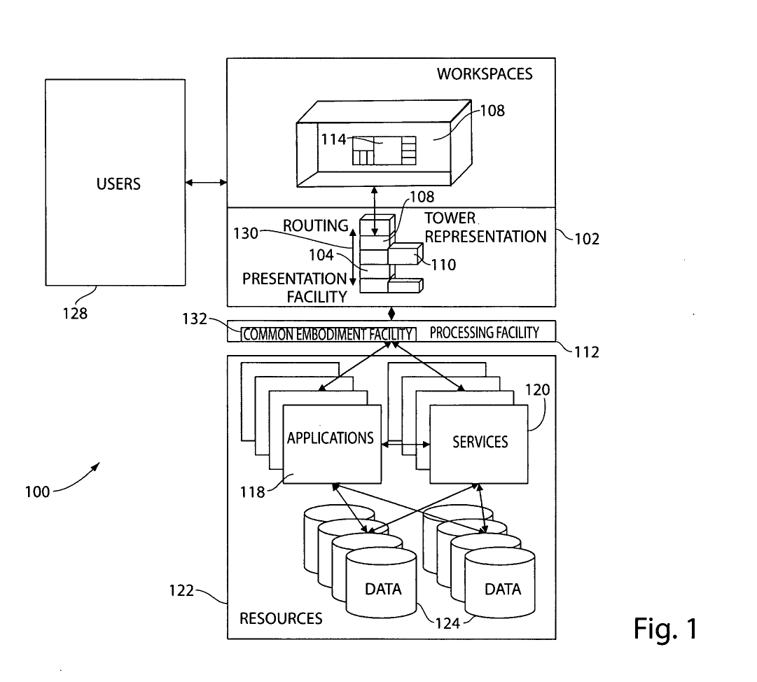

Referring now to FIG. 1, a system 100 according to the present invention may comprise a presentation facility 102; a tower representation 104; a workspace 108; an episodic workspace 110; a processing facility 112; a content object 114; any number of applications 118; any number of services 120; any number of resources 122; any number of data facilities 124; one or more users 128; a routing facility 130; a common embodiment facility 132; and various other elements.

The user 128 may be associated with the presentation facility 102, which may provide a graphical user interface to the user 128 and which may receive input from the user 128. In embodiments, the user input may comprise textual input, a mouse movement, a mouse click, and so forth. Likewise in embodiments, the graphical user interface of the presentation facility 102 may encompass a visual manifestation of real or simulated physical space, which may be associated with a logical space or mental model.

In embodiments the graphical user interface of the presentation facility 102 may encompass a tower representation 104. In one preferred embodiment, the tower representation 102 may consist of a predefined number of workspaces 108, each of which is designed for a user to work on content objects 114 contained therein. The workspaces 108 allow users to access content objects 114. The content objects 114 may be of various types, such as documents, generated or delivered by various resources 122, such as applications 118, services 120, and data facilities 124, each of which in the various embodiments disclosed herein may be stored or accessed internally within a personal computer of a user 128 or externally from other computers, networks, or similar resources. In embodiments the workspaces 108 are presented adjacent to each other in the tower representation 104, such as in a vertical stack of room- or box-like workspaces 108, or presented in a horizontal row of the same. In other embodiments the number of workspaces 108, rather than being predefined in number, may be unlimited in number. Having a predefined number of workspaces 108 may provide certain advantages, such as simplifying the user experience.

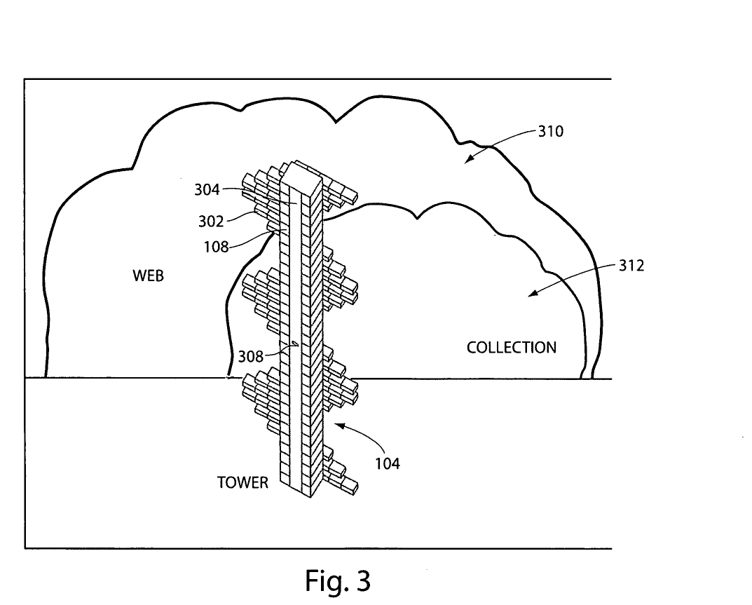

In various alternative embodiments, the tower representation 104 may comprise a visual manifestation of any number of workspaces 108, content objects 114, and associated interfaces to resources 122, which again may include various applications 118, services 120 and data facilities 124. In embodiments the workspaces 108 are arranged in a tower-like physical configuration. This configuration 104 and its routing facility 130 are described in detail hereinafter with reference to FIG. 3 and subsequent figures.

In various alternate embodiments, the graphical user interface of the presentation facility 102 may, in addition to or instead of the tower representation 104, encompass a representation of a circular physical configuration, a representation of grid-like physical configuration, a representation of a topographical physical configuration, a representation of a two-dimensional physical configuration, a representation of a three-dimensional physical configuration, or any and all other representations of a physical configurations of workspaces 108, content objects 114, and associated interfaces to resources 122, such as applications 118, services 120 and data facilities 124. The interfaces may be associated with a physical object in the space. In other words, the interfaces may encompass a physical object, be provided as a surface or texture of a physical object, be provided as an illumination of a physical object, and so forth.

The presentation facility 102, such as the tower representation 104 may provide a view, from a viewpoint, of a space, which a user may perceive as similar to a physical space. For example, the representation 104 may be a three-dimensional visualization of the space, so that, among other things, the user perceives various objects in the representation 104 in perspective view, such that a given object appears smaller when it is more distant and larger when it is closer, and such that a closer object may overlap a more distant object, blocking the user's view of part or all of the more distant object. Like physical objects, objects may vary in their opacity or transparency within the representation 104, so that some more distant objects can be seen through transparent or partially transparent closer objects. From time to time, the viewpoint may shift through the space a continuous manner that serves to keep the user 128 oriented in the space, moving some objects closer and rendering other objects more distant (or causing them to disappear “behind” the perspective of the user as the viewpoint of the user moves past them or rotates away from them. In embodiments, any and all transitions of the viewpoint may be presented so as to occur in a visually smooth manner, with the viewpoint following a continuous path through the physical space, and thus without discontinuities in the user's perception of the representation 104. In embodiments the viewpoint may be required to follow certain rules, such as stored in a data facility 124 and executed by the processing facility 112. A collection of such rules may form an “action grammar” for the representation 104, representing the kinds of actions, shifts of viewpoint, and movements of content objects that are allowed or prohibited within the representation 104. In embodiments an action grammar may be predefined for a representation 104, such as a representation 104 that is intended to govern an operating system of a personal computer, so that parties developing resources 122, such as interfaces to applications 118, services 120 and data facilities 124 accessed on the personal computer, are required to adhere to the predefined action grammar when developing the same for use on the personal computer. By way of example, the action grammar may require that a change in a viewpoint only take place in response to an action by a user 128, so that a user 128 does not experience unexpected actions, such as appearance, disappearance, movement or resizing of windows, appearance, disappearance, movement or resizing of documents or other content objects, unexpected launching of applications, or the like. In embodiments, certain rules of the action grammar may be mandatory, and other elements may be optional. In embodiments some or all rules of an action grammar may be dictated by a user; for example, a user may be allowed to suspend certain rules of the action grammar, such as to allow certain actions that violate that requirements, such as allowing certain movements that do not maintain a continuous perception of the physical space within the tower representation 104.

In certain embodiments, an action grammar may dictate that transports, dispatches, transfers, or other movements of objects through the representation 104 (such as and without limitation the transport of a content object 114 from one workspace to another; from one floor in the tower representation 104 to another floor; and so forth) may occur in a visually smooth manner, with the element following a continuous path through the perceived physical space and, perhaps, with the viewpoint following the element along its path. In embodiments, when the viewpoint follows the element along its path, the viewpoint may take a parallel path, a cinematic path that is associated with the element's path, or any other path. For example and without limitation, the element may be a content object 114, which may be transported from one floor in the tower 104 to another 104.

As noted above, the presentation facility 102, such as a tower representation 104, may provide perceptual continuity of the view seen by the user 128, which may comport with the user's 128 perceptions of physical space. For example and without limitation, under various optional embodiments of an action grammar, a visual object may be prohibited from instantly appearing or disappearing from the view, without an action of the user 128 that would intentionally cause such appearance or disappearance. Instead, continuing with the example, an event in the view may be shown as a movement, which may include an apparent change in the viewpoint, an apparent change in the perspective of the view, a movement or scaling of an object seen within the view, and the like.

In embodiments, an action grammar may require that a content object 114 be directly rendered in the view, such as instead of being rendered as an icon, link, or the like. Depending upon the size of the rendering, the position of the rendering within the presentation facility 102, or any and all other factors, this rendering may be provided at a level of detail that is consistent with the physical space of the tower representation 104 and with a perspective of the user 128. The level of detail may be determined using an optimization, a heuristic, an algorithm, a program, or the like, such as designed to optimize the ability of a user 128 use a content object 114 while maintaining perspective as to the position of the content object 114 relative to other content objects 114 in the tower representation 104. Thus, rather than being required to keep track of icons, which may alternatively represent applications, services, documents, files, or other items, a user 128 just keeps track of the content objects 114 themselves, as each content object 114 is the actual document, rather than a mere icon, link or representation of the object 114.

In certain embodiments the action grammar may dictate the circumstances in which content objects 114 move; in particular, the action grammar may prohibit movement of content objects 114 except under the action of a user 128. Thus, if a user places a content object 114 in a position in a workspace 108 of the tower representation 104, the content object 114 may be maintained in that position of the workspace 108 until the user 128 takes an action to move the content object 114, even if the user 128 has shifted the viewpoint so as to see another workspace 108 within the tower representation 104. When the viewpoint returns to the workspace 108 where the user 128 left the content object 114, the content object 114 remains where the user 128 left it, just as would be the case if the user left an object in a physical space, departed the space, and returned to that space later. Thus, rather than having content objects 114 disappear into files that are located in directories, or similar arrangements, which require the user 128 to remember the file name of the content object 114 (which may or may not bear a logical connection to the content object 114) and location of the content object 114 within an abstract hierarchy of files (of which the user may or may not be aware), the user 128 just remembers where the user left the content object 114 in the user's 128 perceived physical space, a workspace 108 within the tower representation 104.

The processing facility 112 may process various resources 122, so that the resources 122 may be accessed through the tower representation 104 according to the rules or action grammar of the tower representation 104. Thus, the processing facility 112 may include various modules, components, applications, services, engines, or the like, operating on one or more hardware components (such as a processor or processors, computers, such as servers, workstations, or the like, or other components, located internally within a computer or accessed externally, such as via a network interface), one or more of which is capable of taking a resource 122, such as an application 118, service 120 (such as a service or process accessed through a registry in a services oriented architecture), or data facility 124 and rendering the presentation of that resource 122 in a manner that is consistent with the action grammar of the tower representation 122. For example, if the resource 122 is a word processing application, the processing facility 112 renders documents handled by that word processing application in the tower representation 104 in a manner that maintains the perceived physical presence of those objects in positions within the representation 104, without need for opening or closing the documents, allowing the user to ignore the file names and hierarchies normally associated with accessing those documents.

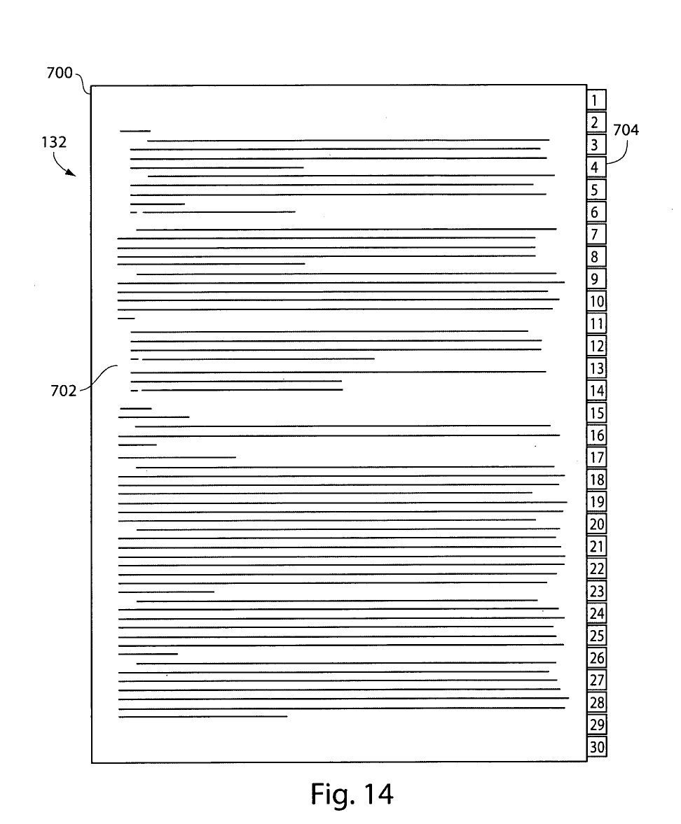

Among other things, the processing facility 112 may comprise a common embodiment facility 132, which is described in detail hereinafter with reference to FIG. 14.

A resource 122 may comprise any number of applications 118, services 120, and/or data facilities 124. Embodiments may provide any number of resources 122. The resources 122 may be available on, accessed by, or provided by any suitable computing facility. The applications 118 may comprise document processing applications, including, without limitation, a word processor, a document management application, a spreadsheet application, a presentation application, a drawing application, a viewer, a reader, and the like. The services 120 may comprise document serving services, including, without limitation, a web server, a file server, a content management system, a document workflow management system, a search engine, a file finding facility, a database management system, a servlet, a server-side application, and so on. The data facilities 124 may comprise any and all local or remote data resources that may be associated with the content objects 114. Such resource may, without limitation, comprise a flat file, a directory of files, a database, a data feed, an archive, a data warehouse, a compact disc, a fixed storage medium, a removable storage medium, a local storage medium, a local storage medium, and so on.

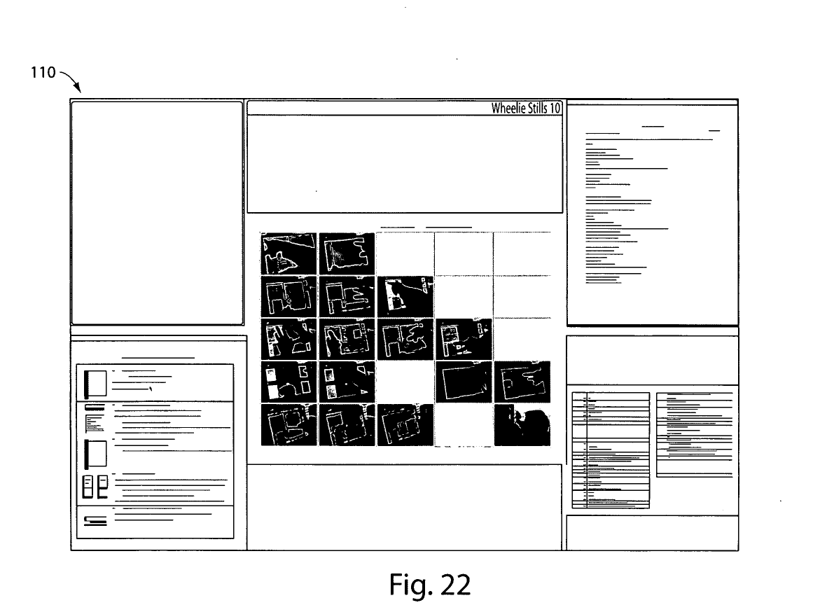

Workspaces 108 in the tower may be represented as adjacent to each other. In embodiments an episodic workspace 110 is provided, which allows a user to group content objects 114 for work that involves such a group of objects. The episodic workspace 110 may be located adjacent to another workspace 110, such as in a horizontally adjacent space on a tower representation 104. The episodic workspace is described in additional detail hereinafter with reference to FIG. 22.

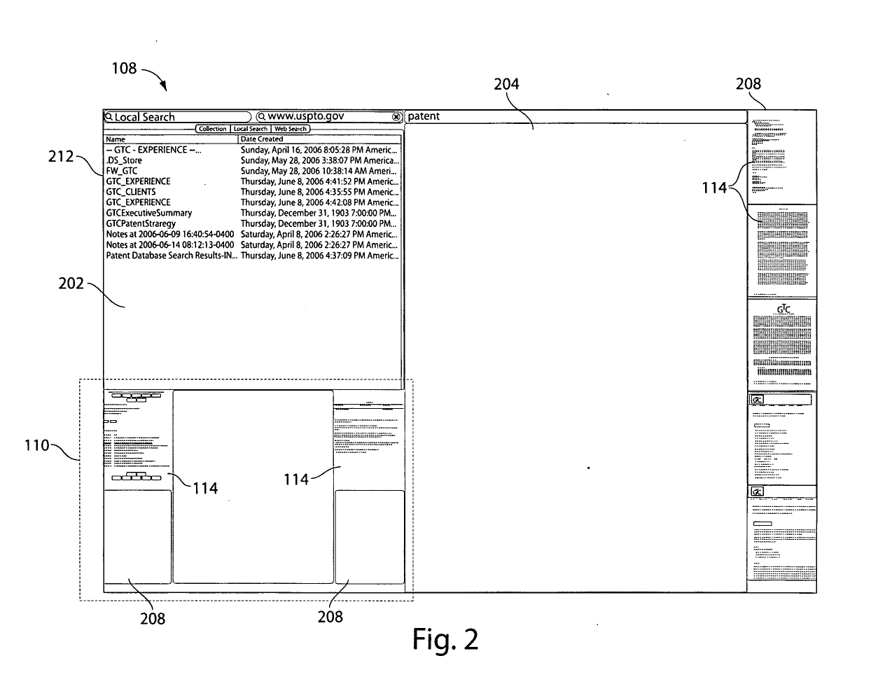

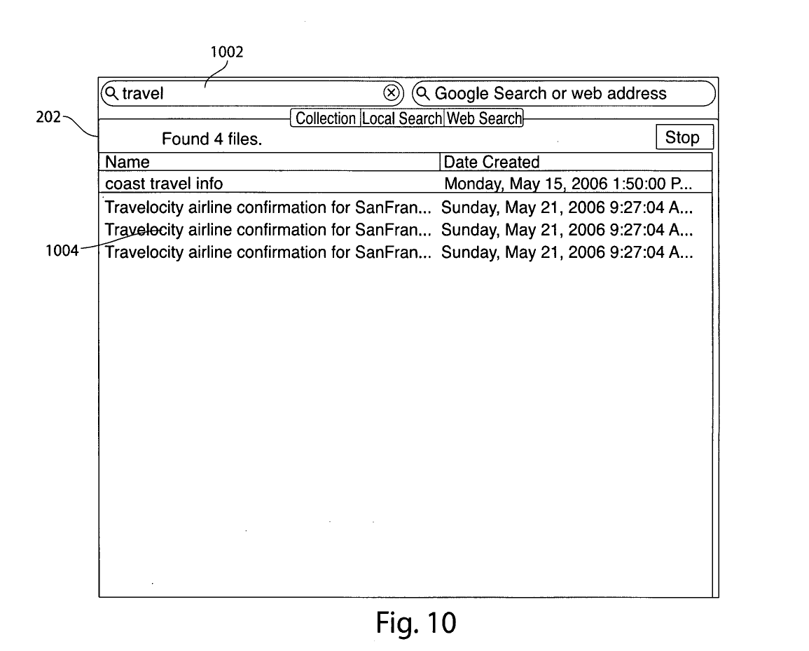

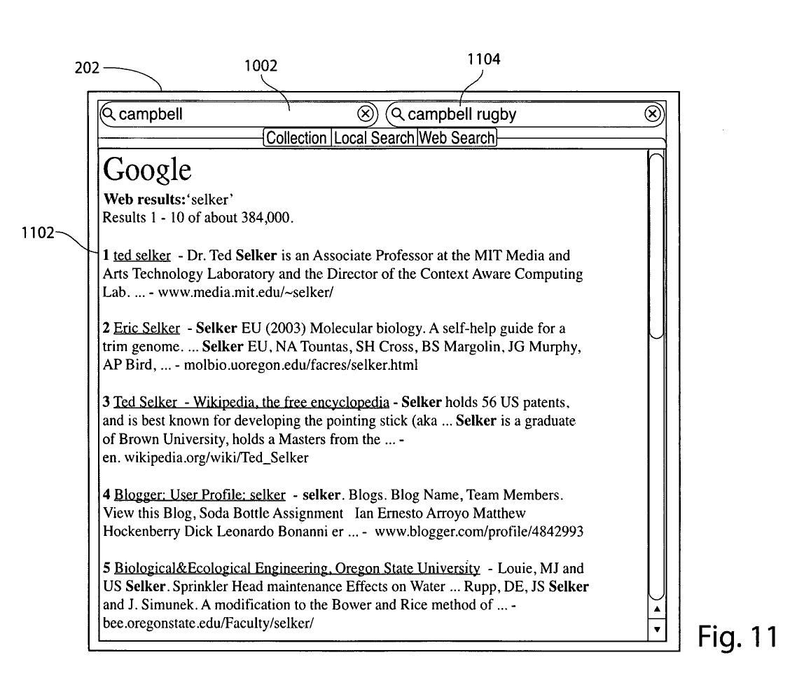

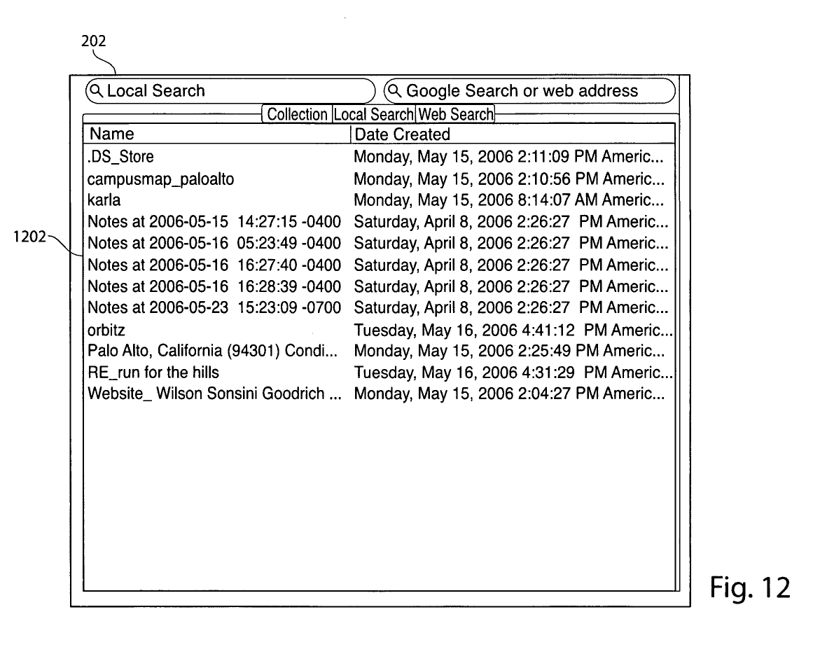

Referring now to FIG. 2, a workspace 108 of a presentation facility 102, such as a tower representation 104, is depicted, in which a user 128 may work on content objects 114, such as documents. The workspace 108 may comprise a focus 204; a side slot 208 in which a user may store content objects 114; an episodic workspace 110. Adjacent to the workspace 108 and presented on the same screen may be an access facility 202. The access facility 202 may comprise an area of the screen that is “outside” the perceived physical space of the tower representation 204, in that it is a space in which items 212 may be represented for possible delivery upon action by a user 128 into the workspace 108, thereby bringing the items 212 into the presentation facility 102, such as the tower representation 204 and turning the abstract items 212 into concrete content objects 114 that follow the rules of the action grammar of the representation 204. The access facility 202, which may optionally operate outside the rules of the action grammar of the presentation facility 102/tower representation 204, is described in detail hereinafter with references to FIG. 10, FIG. 11, and FIG. 12.

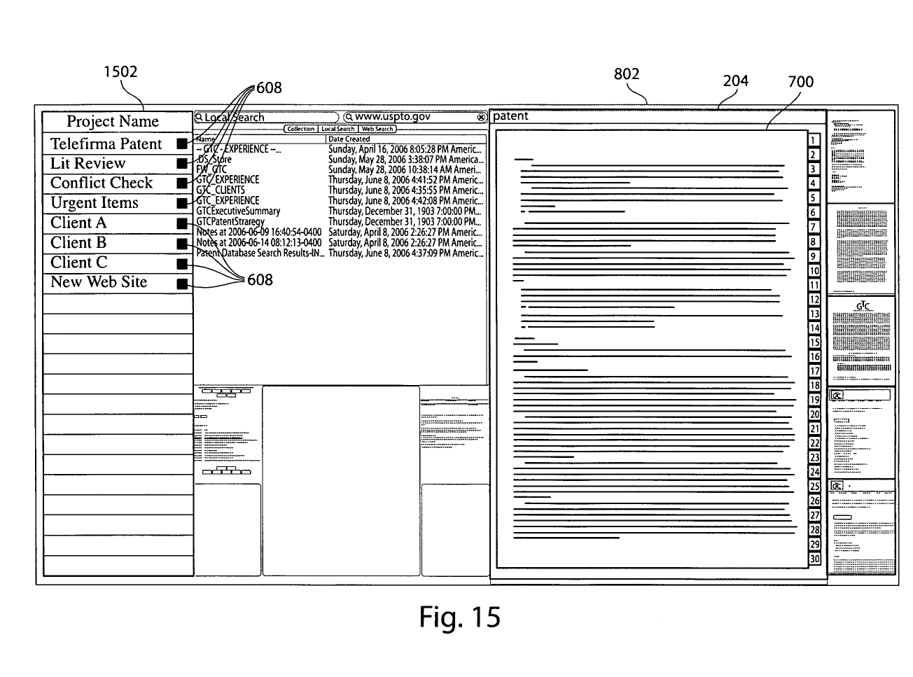

Within the workspace 108, the focus 204 is described in detail throughout this document, and in particular with reference to FIG. 14. The focus 204 is a large, substantially central position of the workspace 108 at which the user 128 may focus primary attention on a content object 114, such as to view or modify the content object 114. The side slots 208 may consist of an arrangement of background holding positions, which are described in detail hereinafter with reference to FIG. 15. In embodiments, this arrangement may be vertical (as depicted), horizontal, two-dimensional, three-dimensional, and so on. In embodiments a content object 114 may have a default side slot 208, where the content object 114 resides upon delivery into the workspace 108 through the access facility 202 until the user 128 brings the object into another position, such as the focus 204. A given side slot 208 may include multiple content objects 114, in which case the content objects 114 are rendered in a stack or pile, optionally with a tab or similar mechanism that allows a user to see that other content objects 114 are stacked behind the visible content object 114 in the side slot 208. The workspace 208 also includes the episodic workspace 110, where a user can group content objects in side slots 208 or in a focus 204 of the episodic workspace 110. A user 128 may move content objects 114 between the side slots 208 (including those of the episodic workspace 110) and the focus 204, or among side slots 208, such as by mouse clicks or drag and drop operations. For example, clicking on a content object in a slide slot 208 may cause that object to enlarge and slide into the focus 204 position. Clicking on a content object 114 in a focus 204 position may cause the object 114 to return to a side slot 208, such as a default side slot 208 for that content object 114. If a content object 114 is in the focus 204, then clicking on a content object 114 in a side slot 208 may cause the content objects 114 to swap positions, with the content object 114 that was previously in the focus 204 moving to the side slot 208 and the content object 114 that was previously in the side slot 208 moving into the focus 204 position. The movements take place according to the action grammar of the presentation facility 102; for example, the movements are visible to the user as perceived physical movements of the content objects 114, rather than having the objects 114 appear or disappear from the workspaces 108 of the representation 104. The episodic workspace 110 (presented here at the bottom left corner of the workspace 110) can be used to group related content objects 114, such as by dragging content objects 114 there from the focus 204 or the side slots 208, or by delivering them there from the access facility 202. Once grouped, a user can move into the episodic workspace 110, at which point the episodic workspace 110 fills the screen, allowing the user 128 to focus closely on the group of content objects 114 placed there by the user. The episodic workspace 110 may also be presented as adjacent to a workspace 108, such as being presented next to it in a horizontally adjacent room in a tower representation 104.

The access facility 202 may allow a user to search for and retrieve various resources 122 that are located outside the tower representation 104, such as files and directories of a local computer, resources accessible by a network, or the like. Thus, the access facility 202 may include a search and/or query capability, for locating resources 122 and a display facility for displaying search results. The display facility of the access facility 122 may include, for example, a list of search results. A user 128 may interact with the search results, such as by clicking on a result, which may deliver a corresponding content object 114, under operation of the processing facility 112, into the workspace 108 and tower representation 204, such as into a side slot 208. The delivery may be seen as a physical delivery, so that the user perceives the location of the new content object 114 in the perceptual space of the representation 104.

The workspace 108 may correspond to the tower representation 104, in that the workspace 108 may represent a flat surface of the perceptual physical space of the tower representation 204, such as a back wall of a “room” within the tower representation 204. Thus a shift of viewpoint may bring a user closer to the workspace 108 until the workspace 108 fills the screen, or the viewpoint may back away from the workspace 108, so that a workspace represents only part of the screen, such as appearing as a surface of a room within the tower representation 104. Thus a user 128 may shift viewpoint from workspace 108 to workspace 108 within the tower representation 104. In embodiments the tower representation 104 may include a space that lists the various workspaces 108, such as workspaces 108 corresponding to various projects of a user 128. For example, the list may list the “floors” of the tower 104, so that a user may shift viewpoint up or down to arrive at a desired floor.

Referring now to FIG. 3, the tower representation 104 may comprise a simulated perceptual space that is associated with a logical space or mental model. The depiction of the tower representation 104 may comprise a visual manifestation of a perceived physical space, represented by an on-screen image. This perceived physical space may have an unambiguous definition of the shape of its structure. In embodiments, that tower representation 104 may comprise a visual representation of stacked workspaces 108, which are depicted to resemble physical, three-dimensional rooms. For example and without limitation, the tower representation 104 may clearly bound the territory that one has to manage into a specified number of floors or vertical levels, such as thirty floors, with a specified number of workspaces 108 per floor, such as three workspaces 108. In embodiments each workspace 108 may include a large central workspace 304 and five satellite workspaces 302 that are accessed from the central one 304. Continuing with the example, there the tower representation 104 may provide a single workspace 308 that moves up and down the front of the tower and, like an elevator car, provides access between floors. In this example, the layout of the five satellite workspaces 302 that adjoin the central one 304 may provide a model of the spatial relationship amongst workspaces. In this example, such an arrangement may aid workflow by breaking content objects 114 or sets thereof into manageable chunks. Also in this example, the tower's 308 finite territory may further support workflow by providing manageability.

In contrast to the tower representation 104, a web 310 of items 212 (such as Worldwide Web objects) or a collection 312 of items (such as files in a directory) are abstract realms, with no real or simulated physical space that has an unambiguous definition of the shape of its structure.

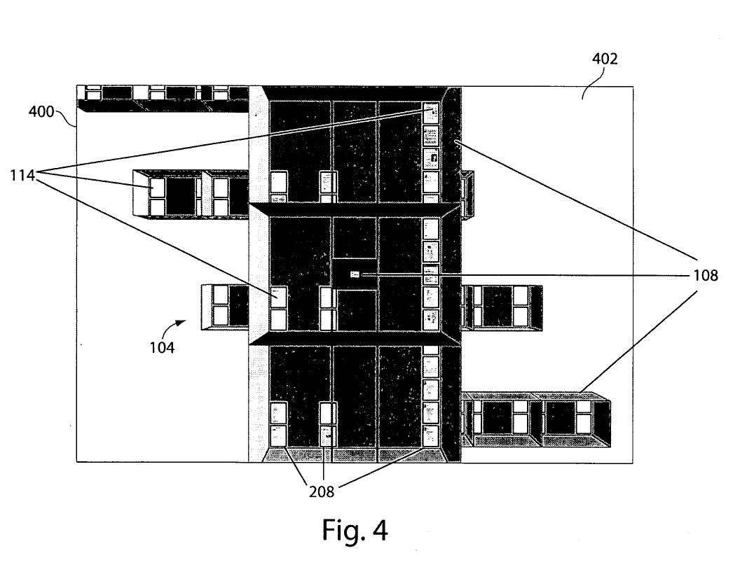

Referring now to FIG. 4, an initial animation (a first snapshot 400 of which is depicted) may serve to perceptually inform the user 128 as to the structure of a working environment 402 (which comprises the tower representation 104) and the spatial relationship between its individual workspaces 108. The particular working environment 402 that is shown here is provided for the purpose of illustration and not limitation. This working environment 402 contains a tower representation 104. The animation may begin with a view of the tower 104 more or less as it is depicted in FIG. 3. Then, then animation may smoothly transition the view's location and/or viewpoint over a more or less continuous path that brings the view closer in on the tower representation 104. As the view moves closer in, the tower representation 104 and its constituent parts may be displayed in a greater level of detail. In any case, the initial animation may comprise this smooth transition.

In this snapshot 400, the constituent parts of the tower include workspaces 108 and content objects 114 along the back walls of the workspaces. The content objects 114 may be presented in regular arrangement, as shown, with the objects 114 arranged in side slots 208.

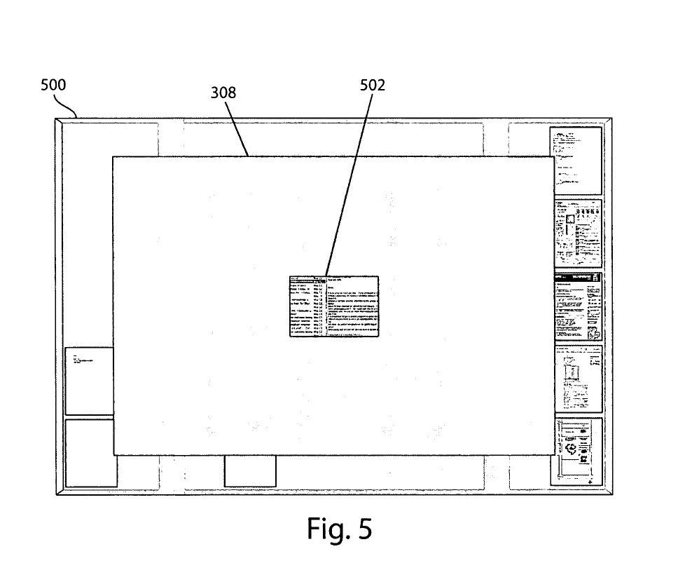

Referring now to FIG. 5, the initial animation (a second snapshot 500 of which is depicted) may continue bringing the view into even closer proximity with the tower 104. In the second snapshot 500, the location of the viewpoint brings the elevator-like workspace 308 into the center of the view. This workspace 308 may comprise the routing facility 130. As the animation continues from the second snapshot 500, the elevator-like workspace 308 may occlude the view of all else. The animation may conclude with the back wall of the elevator-like workspace 308 (such back wall of the elevator-like workspace 308 alternatively described herein as a navigation actuation panel, which in turn is an embodiment of a routing facility 130) entirely filling the presentation facility 102.

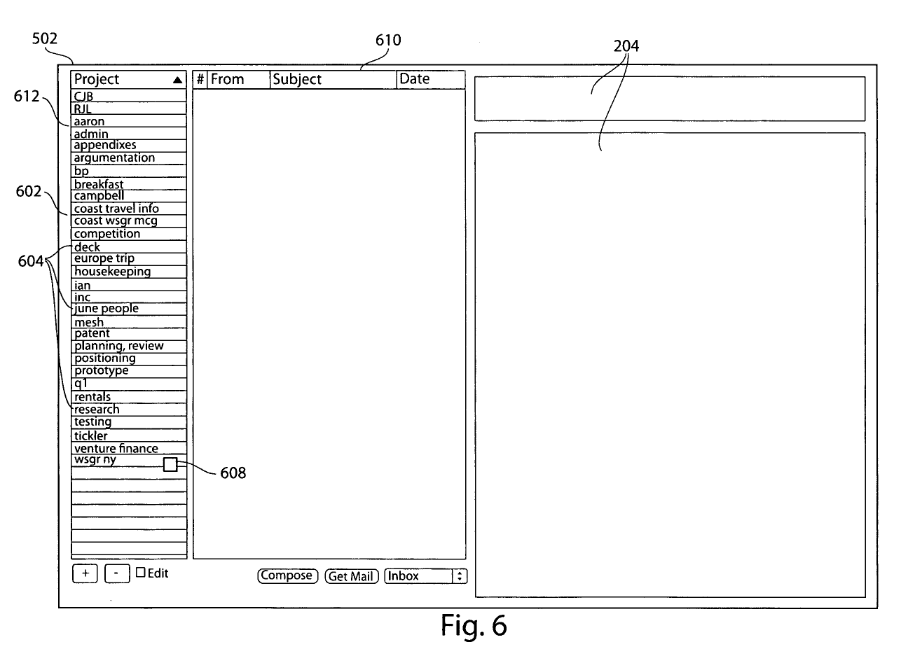

The elevator-like workspace 308 may provide the user 128 with ingress to a workspace 108 for a project that is associated with its physical location. In other words, the elevator-like workspace 308 may provide ingress to floors of the tower representation 104. Additionally or alternatively, the elevator-like workspace 308 may provide the user 128 with a way of switching between projects. Additionally or alternatively, the elevator-like workspace 308 may include the navigation actuation panel, which provides a routing capability that serves as a universal inbox for mail, data feeds, e.g., RSS feeds, or the like, including email, intra-tower mail, or the like. Additionally or alternatively, the navigation actuation panel of the elevator-like workspace 308 may provide the user 128 with a way of dispatching messages to various projects, which may or may not be associated with the user 128. Any and all of the things that the elevator-like workspace 308 may provide to the user 128 may be accessed by the user 128 through a navigation actuation panel, as depicted in connection with FIG. 6.

Referring now to FIG. 6, within the tower representation 104, a project panel 612 of a navigation actuation panel may comprise a vertical arrangement 602 of project buttons 604, each of which may correspond to a project (such as and without limitation a floor in the tower representation 104). By selecting a project button 604, the user 128 may trigger a transition from the elevator-like workspace 308 and/or the navigation actuation panel 502 to the project that corresponds with the selected project button 604. In embodiments, the user 128 may select the project button 604 by clicking on the project button 604. The transition may occur in a visually smooth manner, with the location of the viewpoint following a more or less continuous path through the physical space of the tower representation 104 from the navigation actuation panel to the workspace 108 of the selected project.

In embodiments, the user may select any and all buttons or visual elements of the presentation facility 102 by clicking on them.

Referring still to FIG. 6, any number of the projects may be associated with a message dispatch button 608 in the navigation actuation panel. In embodiments, each dispatch button 608 may appear to the right of the project's project button 604. When the user 128 selects the dispatch button 608, a visible content object 114 may be transported to its associated project workspace 108, such as appearing in the access panel 202 associated with that workspace 108, for later delivery into the workspace 108. This transport may be depicted as a transition. In embodiments, the user 128 may access the content object 114 in a focus 204 of the project. In embodiments the user sees the content object 114 move to the particular project, then the viewpoint either is returned to the navigation actuation panel or is left with the workspace 108. In embodiments buttons of the navigation actuation panel may give user options, such as to follow a content object 114 to a selected project workspace 108, to send the object to the project workspace 108 without viewing the delivery of the content object 114, or the deliver the content object 114 to the workspace 114 and show the user 128 where the workspace 108 is within the tower representation 104.

The navigation actuation panel may comprise an inbox index display 610. This display 610 may provide a view of an inbox that is associated with the user 128. The inbox may contain email messages and intra-tower mail messages. Each message in the inbox may be displayed in a summary form and in one row of the display 610. In embodiments, the summary form may include the “from” address of the message, the subject of the message, and the date on which the message was sent. Additionally or alternatively include the beginning of the body of the message. In any case, the user 128 may select a message by selecting its summary in the display 610. This may cause the message to be transported to the focus 204 of the navigation actuation panel. (In the present depiction, which is provided for the purpose of illustration and not limitation, the focus 204 consists of two windows.) Once the message has been transported into the focus 204, it may disappear from the index to indicate that the message is now inside the tower 104. Alternatively, the message may be routed to a particular workspace 108 for future work.

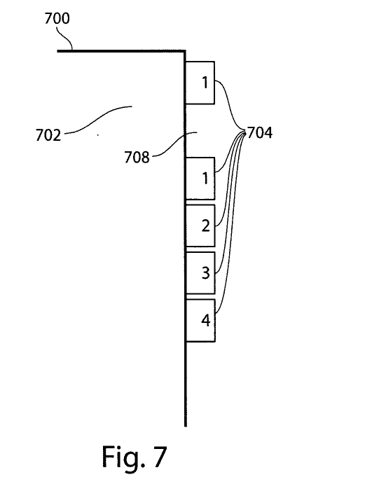

Referring now to FIG. 7, all attachments to a mail message may be displayed, within the tower representation 104, as one or more series of content surfaces 702 in a content pile 700, whereby access to any attachment is accomplished as though accessing another page in a document, and therefore without any need to relocate the view within the presentation facility 102. The mail message itself may be the top surface in the pile, with the attachments each appearing as a surface or surfaces behind that. A tab 704 may be associated with each page in the mail message, including each page in the attachments. In embodiments, the tabs 704 may contain the tab's page's number. In embodiments, the numbers may start at “1” for the first page in the mail and may reset to “1” at the beginning of each attachment. In embodiments, the tabs may be arranged in a column off the right edge of the pile 700. In embodiments, the separate surfaces may be visually indicated in the pile by a break 708 in the column. An expanded view of a content pile 700 is depicted in FIG. 14.

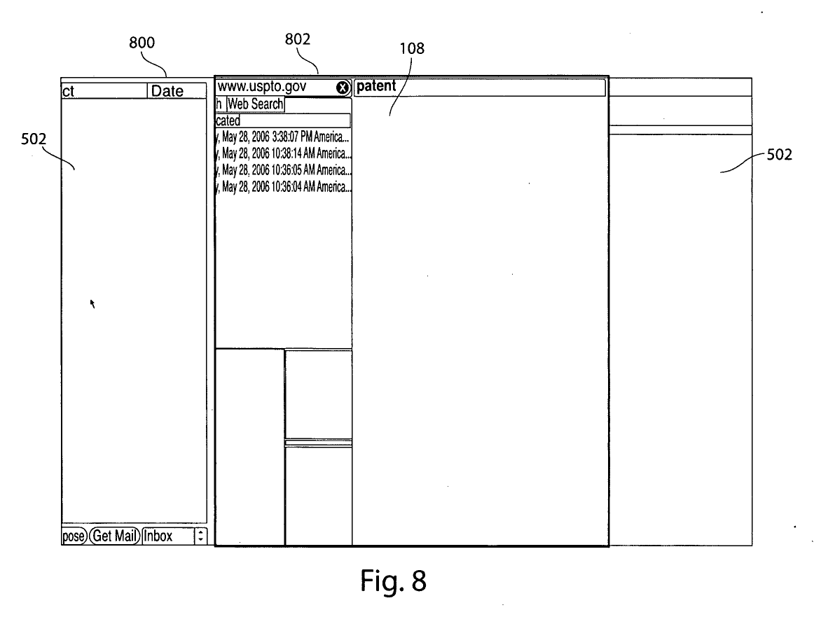

Referring now to FIG. 8, a barn-door animation associated with the tower representation 104 (a snapshot 800 of the animation is depicted) may occur when the user 128 selects a project from the navigation actuation panel. In this snapshot 800, the actuation panel 502 is bisected, with the left half sliding off the left of the presentation facility 102 and the right half sliding off the right of the presentation facility 102, akin to the sliding open of barn doors. As the navigation actuation panel 502 slides off, a staging workspace 802 is revealed behind it. This may constitute a transition from the navigation actual panel 502 of the routing facility 130 to the staging workspace 802 of a workspace 108 of a project.

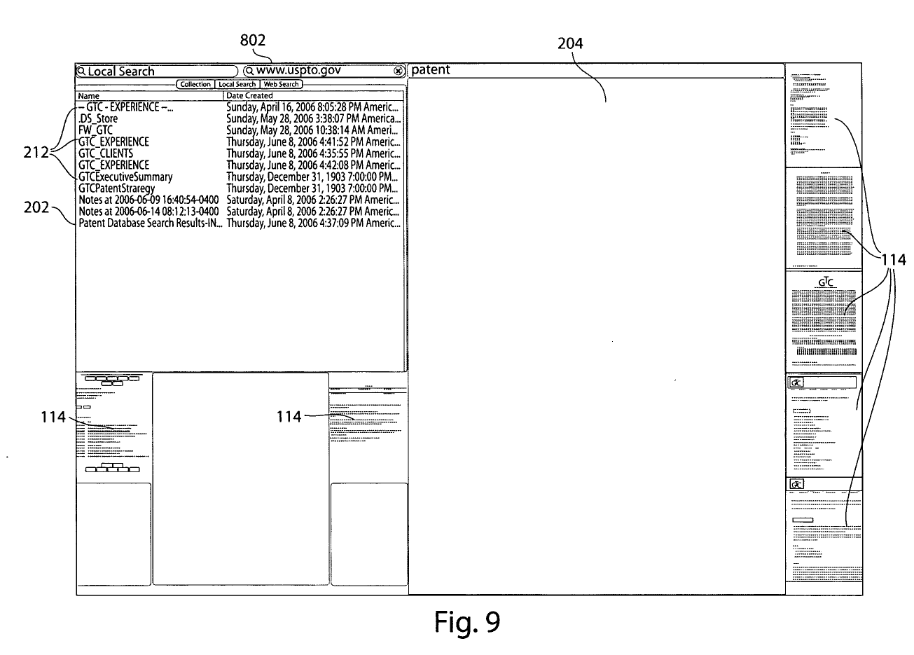

Referring now to FIG. 9, the staging workspace 802 may be a project's central workspace 108. The staging workspace 802 may, without limitation, provide the user 128 with a way of arranging a plurality of content piles 700, optionally according to an orderly and automatically positioned (and optionally pre-defined) scheme; a way of accessing satellite workspaces 302, including episodic workspaces 110; a way of accessing content objects 114 from a collection 312 or a web 310; a coordinated set of actions for moving content piles 700 back and forth between a background position and a foreground position, or focus 204; and so on. In this depiction, which is provided for the purpose of illustration and not limitation, items 212 associated with a web 310 are provided in summary form in the access facility 202, wherein the summary form consists of the name of the item 212 and the date it was created. The summary forms 212 may appear in a web access facility of the staging workspace 802.

The user 128 may select a content object 114 of the web 310, which may cause the content object 114 to be transported into the focus 204. Once in the focus 204, the content object 114 may be contained within the staging workspace 802 and thus may be available within the system 100 as a content object 114. Likewise, a content object 114 may be copied or transported out of the staging workspace 802 and back into the web 310. In embodiments, the user 128 may achieve this by dragging and dropping a content object 114 into the area or access facility 202 of the presentation facility 102 where the summary forms 212 appear.

Referring now to FIG. 10, the tower representation 104 may provide an access facility 202 for searching local documents. The access facility 202 may provide a collection of individual controls that, individually or taken together, provide a way for the user 128 to access contents of a local computer (including ones not depicted on the tower representation 104) and deliver content items 114 to the staging workspace 802. The presentation facility 102 may provide a way of accessing content objects 114 that are not in the tower 104. This control may comprise a local-documents query field 1002 and a local-documents query results list 1004 (referred to herein as “collection results”), which together allow for accessing documents from a collection 312. In embodiments, the collection 312 may be associated with the user 128. The collection results 1004 may present a summary for each of the content objects 114 within the collection 312 that match a search term, which the user 128 provides in the local-documents query field 1002. In the depiction, which is provided for the purpose of illustration and not limitation, the user 128 has entered the search term “travel” and summaries appear in the collection results 1004. In this example, the summaries include the name of the content objects 114 and the creation dates of the content objects 114.

Referring now to FIG. 11, the tower representation 104 may additionally or alternatively provide the access facility 202 for web documents search. The access facility 1100 may provide a web-search query field 1104 and a webpage query results list 1102 (referred to herein as “web results”). The access facility 202 may automatically toggle between displaying the web results 1102 and the collection results 1004, depending upon whether the user 128 issued a query via web-search query field 1104 or the local-documents query field 1002, respectively. The depiction, which is provide for the purpose of illustration and not limitation, shows the web results 1102 as provided by Google. It will be appreciated that any web search engine may be utilized in association with the system 100. Once an item is located by a web search and an associated display, such as a link, is depicted in the access facility 202 associated with a workspace 108, the user may bring the item into the tower representation 104, such as by clicking on or dragging the item, at which point the item is brought, for example, into the focus 204 of the workspace 108, and, under control of the processor 112, becomes a content item 114 that responds to the action grammar rules of the presentation facility 102, such as the rules requiring that the content object 114 behave in a manner that preserves the perceptual continuity of the space for the user 128.

Referring now to FIG. 12, the tower representation 104 may additionally or alternatively provide the access facility 202 for displaying an annexed objects list 1202, wherein objects are associated with an annex. The annex may contain objects (referred to herein as “annexed objects”) that are associated with a collection 312 associated with a workspace 108, but that are not visible within the workspace 108. Thus, the annex allows a user 128 to keep selected content objects 114 in isolation from a larger set of content objects 114 that may be associated with an archive of the system 100. The annexed content objects 114 may be displayed in the annexed content objects list 1202 as summaries. In this example, the summaries include the name of the content objects 114 and the creation dates of the content objects 114.

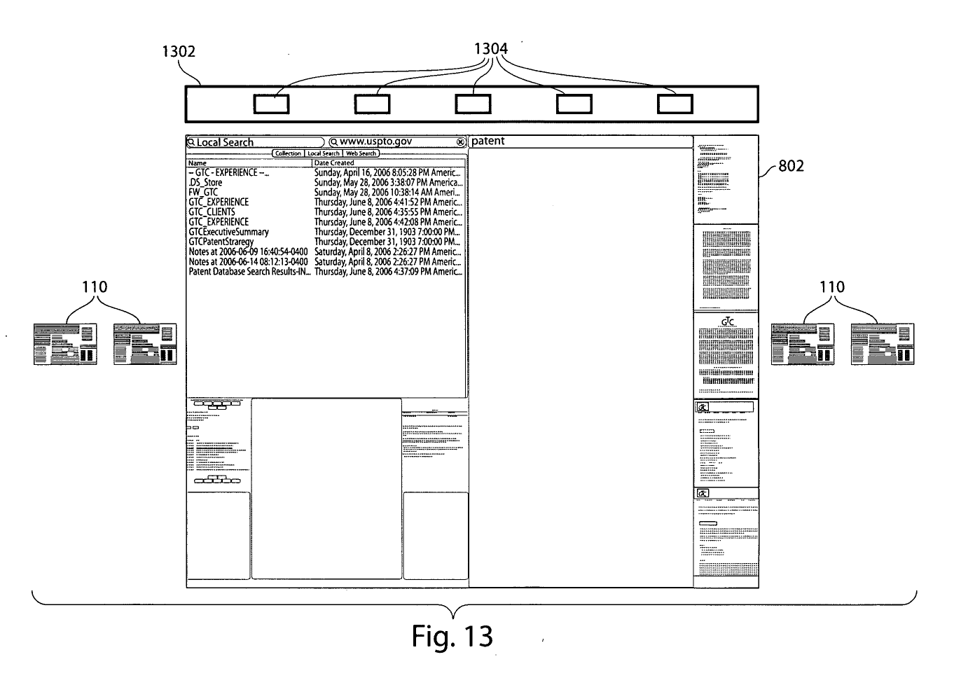

Referring now to FIG. 13, the tower representation 104 may provide a control bar 1302 containing any number of buttons 1304, wherein each of the buttons is associated with an episodic workspace 110. (The episodic workspace 110 is described in detail hereinafter with reference to FIG. 22.) In the figure, which is provided for the purpose of illustration and not limitation, there are five buttons 1304 corresponding to five episode workspaces 1308, four of which are displayed in a miniature with a low level of detail and one of which is displayed in the staging workspace 802. When the user 128 selects a button 1304, the associated episodic workspace 110 may be brought into the staging workspace 802, ejecting the episodic workspace 110 that previously occupied the staging workspace 802. Visually, this bringing in and ejecting may be provided by laterally moving the episode workspaces 1308, as a row, behind the staging workspace 802 until the episode workspaces 1308 that is associated with the selected button 1304 is properly lined up in the staging workspace. As episode workspaces 1308 slide toward and/or into the staging workspace 802, they may become larger and depicted at a higher level of detail. Conversely, as episode workspaces 1308 slide away and/or out of the staging workspace, they may become smaller and depicted at a lower level of detail.

Referring now to FIG. 14, the tower representation 104 may provide a common content embodiment and presentation facility 132 (referred to herein as the “common embodiment facility”) whereby content objects 114 of a variety of types may be handled and navigated uniformly and, perhaps, without necessitating movement to another workspace 108, opening of a new application, or the like. The focus 204 may encompass the comment common embodiment facility 132. In embodiments, the content object 114 types may include Word document files, WordPerfect files, Rich Text Format files, HTML files, EML files, PDF files, QuickTime files, Flash files, and the like. Alternatively or additionally, the variety of content objects 114 may be handled in a manner that appears, the user 128, to not launch an application to deal one or more of the content objects 114. For example and without limitation, a user 128 may be viewing a content object 114 via the common embodiment facility 132. The content object 114 may be a PDF file. Then, the user may transport a second content object 114 into the common embodiment facility 132. This content object 114 may be an HTML file. Without any outward appearance of loading a new software application to handle the HTML file or switching software applications to handle the HTML file, the common embodiment facility 132 may display the HTML file, either along with the PDF file or instead of the PDF file. While the foregoing example refers to particular file types and a particular number of files, it will be appreciated that any and all files types and any number of files may be utilized accordingly. In addition to viewing the content items 114 in the focus 204, the user can manipulate, and optionally modify, the content items 114 in the focus 204, such as using a common set of tool bars or editing options, which in turn, under operation of the processing facility 112, invoke the necessary interfaces to the resources 122 to effect the modifications in the files or other objects underlying the content objects 114, such as interacting with a document in Microsoft Word, modifying the underlying document, and showing a modified content object 114, without a user having to launch or navigate to a separate application. The user would make the same edits to another type of document type, such as a PDF file, in which case the processing facility 112 would undertake corresponding actions with different underlying resources 122, such as a PDF editor, such as Adobe Acrobat.

The common embodiment facility 132 may also provide for stacking multiple content objects 114 on top of one another, perhaps forming a content pile 700. The content pile 700 may be utilized as a single content object 114. For example and without limitation, the content pile 700 may be positioned, transported, or otherwise moved about the physical space and/or any and all of the workspaces 108 of the presentation facility 102.

The common embodiment facility 132 may function by converting any and all content objects 114 that it receives from a source content object type into a common content object type. The common embodiment facility 132 may comprise a single WYSIWYG editor for that common type, thus providing a common editing and display capability across all content object types. The conversion of the content object may be automatic and may occur without the user's 128 knowledge. In embodiments, the common type may be PDF and the WYSIWYG editor may be Adobe Acrobat. In embodiments, the common type may be OASIS and the WYSIWYG editor may be OpenOffice. In embodiments, the common type may be HTML and the WYSIWYG editor may be Writely. Many other common types and editors will be appreciated and all such formats and editors are intended to fall within the scope of the present invention.

The common embodiment facility 132 may function by providing both a WYSIWYG editor that accepts a plurality of content object types and at least one application for converting content objects into at least one of those types. When a content object 114 is received by the common embodiment facility 132, a test may determine whether that content object is of a type that the editor accepts. If the result of this test is negative, then at least one of the applications for converting content objects may be automatically applied to the content object, thus converting the content object into a type that the editor accepts. The conversion of the content object may be automatic and may occur without the user's 128 knowledge. If the result of the test is positive or if the content object has been converted to an acceptable type, then the content object is simply passed to the editor, which may automatically load it.

The common embodiment facility 132 may function my providing a WYSIWYG editor within a webpage. The editor may contain client-side code (such as and without limitation Javascript) that allows a content object to be edited within the webpage. This code may function entirely in the webpage or may work in conjunction with a server application running in a web server (such as and without limitation according to the Ajax programming technique). Depending upon which type of content object is within the common embodiment facility 132, the editor may ask for and/or receive additional or alternate client-side code that is directed at handling the type. Additionally or alternatively, the sever application may adapt itself to be compatible with the type, such as by running a different routine, accessing a different dynamically linked library, and so forth.

The common embodiment facility 132 may be associated with a content object integration facility that combines multiple content objects 114 into a single content object 114. The single content object 114 may be in a format that is compatible with a WYSIWYG editor of the common embodiment facility 132. The single content object 114 may encompass a stack 700. In embodiments, the content objects 114 may consist of digital documents in file formats associated with Microsoft Office and the content object integration facility may encompass Adobe Acrobat.

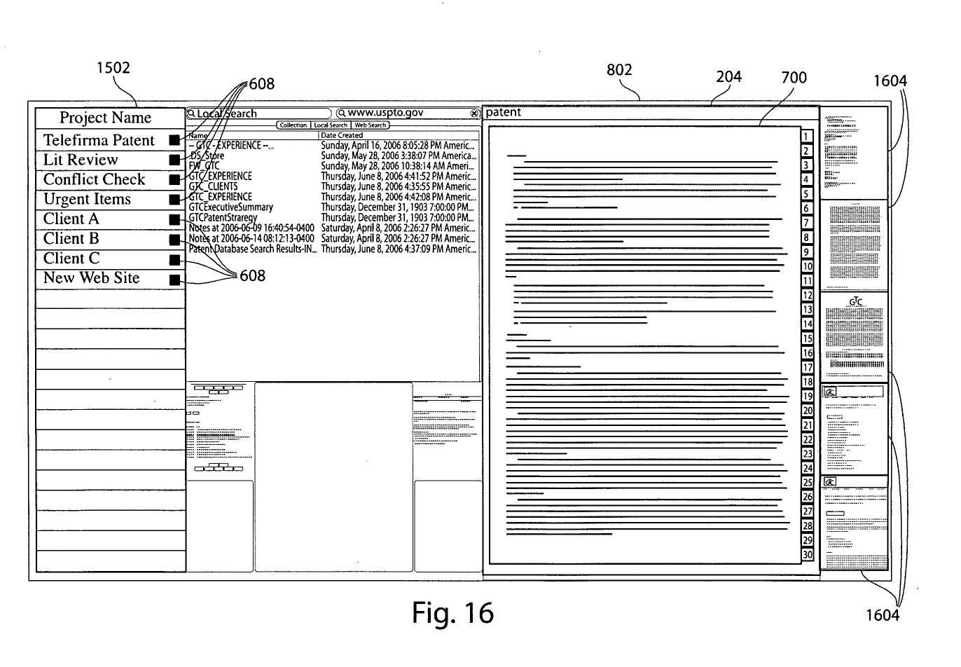

Referring to FIG. 15, embodiments of the tower representation 104 may provide a mail address bar 1502. In embodiments, the mail address bar 1502 may be associated with a staging workspace 802 and/or an episodic workspace 110. The depiction, which is provided for the purpose of illustration and not limitation, shows the mail address bar 1502 in association with a staging workspace 802. The mail address bar 1502 may comprise a panel of project buttons 604, each of which are associated with a message dispatch button 608, whereby a content pile 700 or any and all other content objects 114 at a focus 204 may be dispatched from a source project's workspace (802, 110) to a destination project's staging workspace 802. This dispatch may be initiated by a user 128 who selects the message dispatch button 608 that is associated with the destination project. As may generally be the case when a content object 114 moves from one location to another, the content object 114 may follow a smooth and continuous path through the physical space. In this case, that path may be from the source project's workspace to the destination project's workspace. Referring to FIG. 16, upon entering the target project's workspace, the content object 114 may be positioned in a topmost background holding position 1604.

Referring still to FIG. 16, a number of other background holding positions 1604 may be available in association with the staging workspace 802. The user 128 may move one or more content objects 114 into any or all of the background holding positions 1604. For example and without limitation, as the user 128 browses a web 310, he may gather information that is relevant to the project by moving the relevant information (in the form of a content object 114) into one or more of the background holding positions 1604. The background holding positions 1504 may encompass a slot or shelf in the physical space for temporary holding of content objects 114. Additionally or alternatively, the background holding positions 1604 may provide an orderly presentation of the content objects 114 that it contains. In embodiments, having a plurality of background holding positions 1604 may provide the user 128 with an efficient method of switching amongst sets of content objects 114.

In embodiments, when the user 128 clicks on a link (such as and without limitation a hyperlink) in a first content object 114 that is in the focus 204, the content object 114 may be automatically moved into the bottommost background holding position 1604 or into the background holding position 1604 in which the content object 114 did most recently reside. Meanwhile, a second content object 114 identified by the link may come into the focus 204. By moving the first content object 114 into the background holding position 1604, the presentation facility 102 may provide the user with a visual history of the last content object 114 visited.

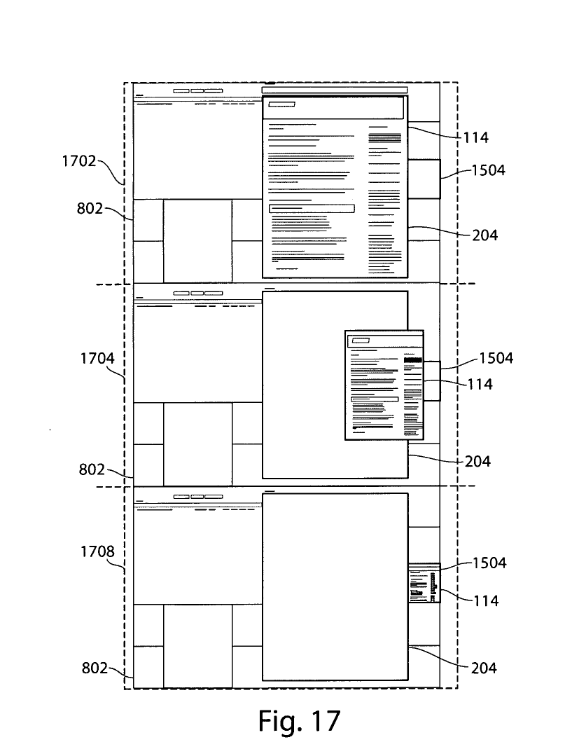

Referring now to FIG. 17, three sequential snapshots 1702, 1704, 1708 of an animation illustrate, within the tower representation 104, a content object 114 moving from a focus 204 of a staging workspace 802 to a background holding position 1504 of the staging workspace 802. In the first snapshot 1702, the focus 204 is entirely occluded by the content object 114 that is occupying it. In the second snapshot 1704, the background holding position 1502 is partially occluded by the content object 114 that is sliding into it. Likewise, in the second snapshot 1704, the focus 204 is partially occluded by the content object 114 that is sliding out of it. In the third snapshot 1708, the background holding position 1504 is entirely occluded by the content object 114 that is occupying it.

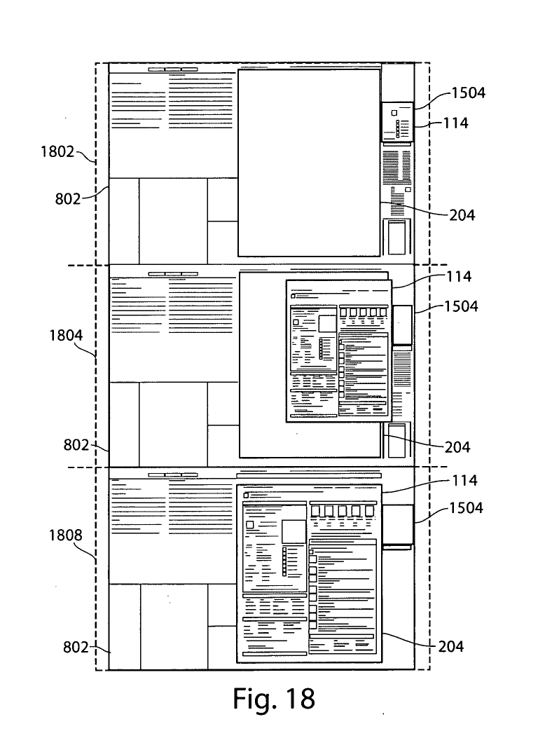

Referring now to FIG. 18, three sequential snapshots 1802, 1804, 1808 of an animation illustrate, within the tower representation 104, a content object 114 moving from a background holding position 1502 to a focus 204. In the first snapshot 1802, the background holding position 1504 is entirely occluded by the content object 114 that is occupying it. In the second snapshot 1804, the background holding position 1504 is partially occluded by the content object 114 that is sliding out of it. Likewise, in the second snapshot 1804, the focus 204 is partially occluded by the content object 114 that is sliding into it. In the third snapshot 1808, the focus 204 is entirely occluded by the content object 114 that is occupying it.

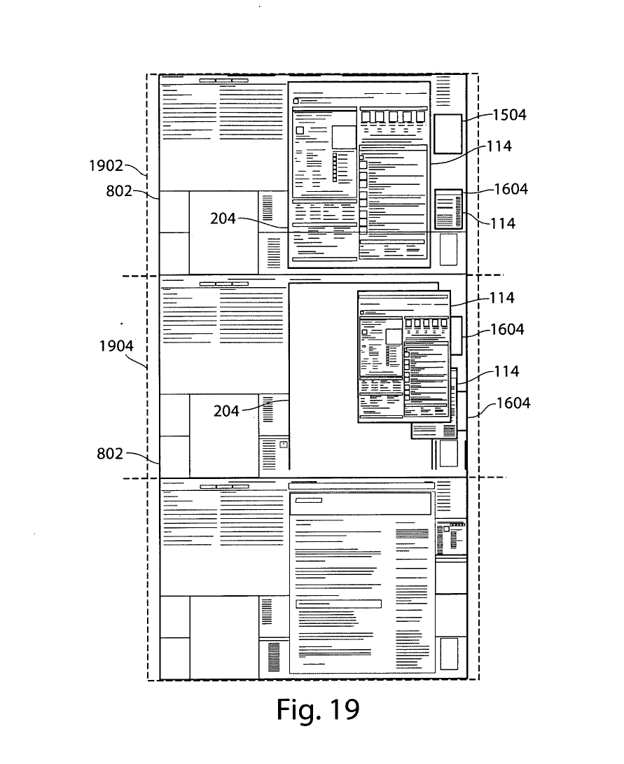

Referring now to FIG. 19, three sequential snapshots 1902, 1904, and 1908 of an animation illustrate, within the tower representation 104, two content objects 114 swapping between a focus 204 and a background holding position 1504. In the first snapshot 1902, the focus 204 is entirely occluded by the content object 114 that is occupying it; one of the background holding positions 1504 is entirely occluded by the content object 114 that is occupying it; and one background holding position 1504 (the topmost, labeled position 1504) is empty. In the second snapshot 1904, both background holding positions 1504 and the focus 204 are partially occluded by one or both of the content objects 114. The visually larger content object 114 is sliding out of the focus 204 and into the empty holding position 1504. The visually smaller content object 114 is sliding out of the background holding position 114 that it had been occupying and into the focus 204.

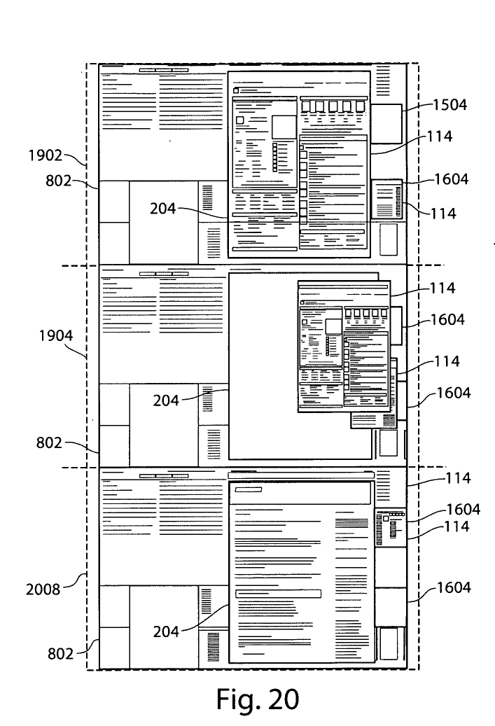

Referring to FIG. 20, in a third snapshot 2008, the content object 114 that had, in the first snapshot 1902, been in a background holding position 1504 is now in the focus 204. That background holding position 1504 (the bottommost, labeled position 1504) is now empty. The content object 114 that had, in the first snapshot 1902, been in the focus 204 is now in what had been the empty background holding position 1504.

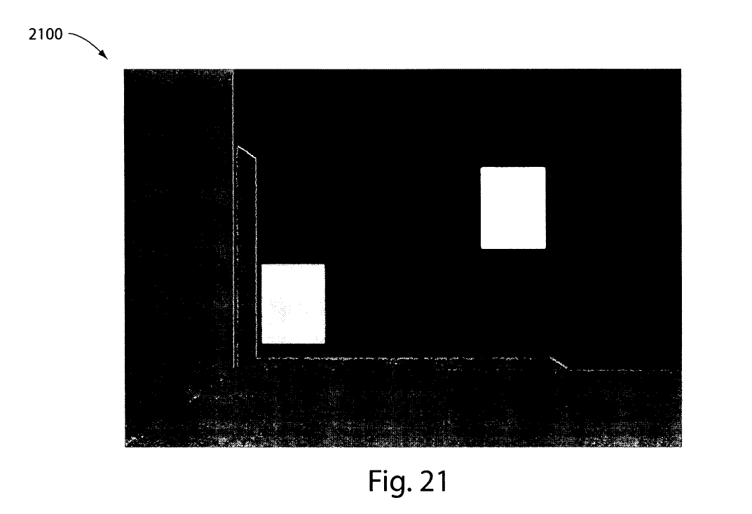

Referring now to FIG. 21, a snapshot 2100 of a viewpoint's transition between a staging workspace 802 and an episodic workspace 110 is provided. As described hereinabove with reference to FIG. 17, this transition may occur in visually smooth manner, with the viewpoint following a more or less continuous path through the physical space. This path may encompass a cinematic path or any other path that may serve to keep the user 128 oriented within the physical space during the transition. Here two episodic workspaces move in view of the user, with one receding and one moving forward to take the front position in the view of the user.

Referring now to FIG. 22, an episodic workspace 110 of the tower representation 104 may be available from a staging workspace 802 and may encompass a smaller work area that provides a consequently larger view of a content object 114 or pile 700. Each episodic workspace 110 may form a sort of navigational cul-de-sac, in that its only egress may or may not be the staging workspace 802 through which it was entered; and also in that it may or may not provide a facility for accessing content objects 114 that are not already in it. This lack of a facility for accessing certain content objects 114 may encompass, for example and without limitation, not including a facility for hypertext linking to content objects 114 that are not already in the episodic workspace 110. In other words, the episodic workspace 110 may provide something of a navigation-free zone that allows the user 128 to focus concentrated efforts on a content object 114 by mitigating the presentation facility's 102 inherently “slippery” or visually dynamic nature.

All of the elements of the system 100 may be depicted throughout the figures with respect to logical boundaries between the elements. According to software or hardware engineering practices, the modules that are depicted may in fact be implemented as individual modules. However, the modules may also be implemented in a more monolithic fashion, with logical boundaries not so clearly defined in the source code, object code, hardware logic, or hardware modules that implement the modules. All such implementations are within the scope of the present invention.

It will be appreciated that the various steps identified and described above may be varied, and that the order of steps may be changed to suit particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

It will be appreciated that the above processes, and steps thereof, may be realized in hardware, software, or any combination of these suitable for a particular application. The hardware may include a general purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device that may be configured to process electronic signals. It will further be appreciated that the process may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across a camera system and/or a computer in a number of ways, or all of the functionality may be integrated into a dedicated, standalone image capture device or other hardware. All such permutations and combinations are intended to fall within the scope of the present disclosure.

It will also be appreciated that means for performing the steps associated with the processes described above may include any of the hardware and/or software described above. In another aspect, each process, including individual process steps described above and combinations thereof, may be embodied in computer executable code that, when executing on one or more computing devices, performs the steps thereof.

While the invention has been disclosed in connection with certain preferred embodiments, other embodiments will be recognized by those of ordinary skill in the art, and all such variations, modifications, and substitutions are intended to fall within the scope of this disclosure. Thus, the invention is to be understood in the broadest sense allowable by law.

All documents referenced herein are hereby incorporated by reference.

1. A method for allowing a user to interact with one or more resources of a computer system, comprising:
providing a tower-based visual representation of a plurality of workspaces disposed in apparent physical adjacency to each other;
disposing at least two of the workspaces vertically in the visual representation; and
presenting at least one of the workspaces to the user in a 3D visualization to resemble a physical room.

2. The method of claim 1, wherein upon a shift of the viewpoint of a user of the visual representation, the user is presented with a continuous perceptual representation of the workspaces.

3. A method for allowing a user to interact with one or more resources of a computer system, comprising:
providing a workspace in which a user can interact with one or more content objects; and
enforcing an action grammar for actions associated with the workspace, whereby movement of content objects within the workspace occurs only in response to a user action.

4. A method for allowing a user to interact with one or more resources of a computer system, comprising:
enabling a change of viewpoint within the visual representation of a plurality of workspaces; and
presenting the change in viewpoint from one workspace to another workspace to the user in a manner that corresponds to the view a user would experience if the user were to make a movement in the physical world.

5-12. (canceled)
